(19) United States
(12) Patent Application Publication
(10) Pub. No.: US 2008/0024241 A1
(43) Pub. Date: Jan. 31, 2008

(54) High-Frequency Coupler, Rf Guide, and Antenna

(76) Inventors: Hiroshi Hata, Nagano (JP); Takahisa Karakama, Nagano (JP)

Correspondence Address: FLYNN THIEL BOUTELL & TANIS, P.C., 2026 RAMBLING ROAD, KALAMAZOO, MI, 49008-1631, US

(21) Appl. No.: 11/661,488

(22) PCT Filed: Apr. 7, 2005
(86) PCT No.: PCT/JP05/06842

§ 371 Date: Feb. 27, 2007

(30) Foreign Application Priority Data
Aug. 27, 2004 (JP) 2004-247822

(51) Int. Cl. H01F 27/28

(52) U.S. Cl. 333/26

(57) ABSTRACT

A high frequency coupler (2) comprising first and second coupler patterns (11, 12) each having an annular shape broken at one location and formed, facing each other, on the front and rear surfaces of a circuit board (10) consisting of a dielectric and being t thick. The terminals (11a, 11b) of the first coupler pattern (11) serve as unbalanced terminals, and the terminals (12a, 12b) of the second coupler pattern (12) serve as unbalanced terminals from which coplanar lines (41, 42) are led out along the rear surface and connected with a balanced antenna (5). Since the first and second coupler patterns (11, 12) are kept in an electrostatic capacity coupling state as well as in a magnetic induction coupling state, the coupler high in transmission efficiency in a broad band can be realized.

### TECHNICAL FIELD

The present invention relates to a high-frequency coupler used to couple two or more high-frequency transmission circuits having different properties, an RF guide comprising the high-frequency coupler, and an antenna comprising the high-frequency coupler.

### BACKGROUND ART

Input/output parts of electronic circuits for handling high-frequency (RF) signals are usually unbalanced transmission lines that are grounded on one side. Therefore, unbalanced coaxial lines or microstrip lines are used for transmission cables that are directly connected to terminals of the input/output parts. In contrast, dipole antennas, loop antennas, and other antennas are balanced. Therefore, an impedance-transforming balun (balance to unbalance transformer) must be provided between the antenna and the transmission cable.

In prior art, transformer in which a copper wire is wrapped around a binocular-shaped ferrite core as shown in FIG. 6(a) is used in the reception of television broadcasts and the like. In contrast, lumped parameter elements such as coils or capacitors are not readily applicable for the microwave band, which has a short wavelength. However, since the wavelength is short, a relatively small-sized balun can be made using a distributed parameter circuit. The most uncomplicated balun used to receive a microwave band is a split-slot-form balun having a configuration shown in FIG. 6(b), wherein a ferrite core is not used. In FIG. 6(b), λ is used to express a free space wavelength of an electromagnetic wave, and points a, b are used to express positions of the terminals on the balanced transmission line side.

In each instance, the balanced transmission line and unbalanced transmission line are merely magnetically coupled, and an equivalent circuit is as shown in FIG. 6(c). In the equivalent circuit, M is used to express mutual induction between the two circuits (coupling strength between coils or mutual inductance), and C1 and C2 are used to express capacities of the unbalanced transmission line and the balanced transmission line, respectively. Each of these has three dimensional structures and is not originally designed to be integrally molded with an antenna or other adjacent element or adjacent transmission line.

In contrast, proposals have been made for planarly configured antennas and baluns in recent television bands (UHF). Using a planar configuration for the antenna and balun will provide a reduction in cost resulting from integral molding, and is therefore advantageous. For example, such a planar configuration is disclosed in the below-described Patent Document 1. A balun having a planar structure is shown in FIG. 7, wherein an unbalanced transmission line-side coupler pattern 101 and a balanced transmission line-side coupler 102 are formed in the same plane. Terminals 101a, 101b of the coupler pattern 101 are unbalanced terminals, and terminals 102a, 102b of the coupler pattern 102 are balanced terminals. Such a coplanar structure is readily manufactured and is therefore advantageous. [Patent Document 1] Japanese Patent No. 3323442.

### DISCLOSURE OF THE INVENTION

However, in a planar configuration in which an antenna and a balun are formed in the same plane, sufficient electrical coupling cannot be produced in the coupling between the balanced line and unbalanced line.

It is an object of the present invention to provide a high-frequency coupler that can form sufficient electrical coupling.

It is also an object of the present invention to provide an RF guide comprising the high-frequency coupler.

It is a further object of the present invention to provide an antenna in which the high-frequency coupler is incorporated as a balun.

(Means Used to Solve the Abovementioned Problems)

In order to resolve the foregoing problems, according to the present invention, a high-frequency coupler is provided that is characterized in comprising:
a circuit board composed of a dielectric body;
a loop-shaped first coupler pattern that is formed on a first board surface of the circuit board and is broken at one location; and
a loop-shaped second coupler pattern that is formed on a second board surface of the circuit board and is broken at one location; wherein
the first coupler pattern and second coupler pattern sandwich the circuit board and are disposed facing each other so that a state of electrostatic capacity coupling and a state of magnetic induction coupling are established.

The first coupler pattern and second coupler pattern preferably have congruent or similar shapes.

The first coupler pattern and second coupler pattern are preferably disposed so that the broken positions thereof are offset 180° about an axis line perpendicular to the circuit board.

According to the present invention RF guide is provided that is characterized in comprising:
the high-frequency coupler of the first, second, or third aspect;
a first high-frequency transmission line pattern that is formed on the first board surface of the circuit board and that is connected to both ends of the first coupler pattern (*2); and
a second high-frequency transmission line pattern that is formed on the second board surface of the circuit board and that is connected to both ends of the second coupler pattern.

When the RF guide of the present invention is used as a balun connected to an antenna, the first high-frequency transmission line pattern may be an unbalanced transmission line and the second high-frequency transmission line pattern may be a balanced transmission line pattern.

In addition, a balun-equipped antenna can be composed of the RF guide having this configuration and the antenna pattern formed on the first board surface of the circuit board and connected to the unbalanced transmission line pattern.

The high-frequency coupler of the present invention can be given a multi-layered configuration. In other words, according to the present invention, a multi-layered high-frequency coupler is provided that is characterized in comprising:
a first circuit board composed of a dielectric body;
a second circuit board composed of a dielectric body and layered on a front surface of the first circuit board;
a loop-shaped first coupler pattern formed on a rear surface of the first circuit board and broken at one location;
a loop-shaped second coupler pattern formed between the first circuit board and second circuit board and broken at one location; and
a loop-shaped third coupler pattern formed on a front surface of the second circuit board; wherein
the first and second coupler patterns sandwich the first circuit board and are disposed facing each other so that a state of mutual electrostatic capacity coupling and a state of magnetic induction coupling are established; and
the second and third coupler patterns sandwich the second circuit board and are disposed facing each other so that a state of mutual electrostatic capacity coupling and a state of magnetic induction coupling are established.

A high-frequency coupler having more layers can be formed by layering one or a more circuit boards on the front surface of the second circuit board and forming a coupler pattern between the circuit boards.

In this instance as well, the first, second, and third coupler patterns preferably have congruent or similar shapes. In addition, the first, second, and third coupler patterns are preferably disposed so that the broken positions thereof are offset about an axis line that is perpendicular to the first and second circuit boards.

(Effect of the Invention)

In the high-frequency coupler of the present invention, the circuit board is supported from either side, and the first coupler pattern and second coupler pattern are disposed facing each other. Therefore, the two patterns are also coupled by electrostatic capacity coupling as well as by magnetic induction coupling. Accordingly, unlike when the patterns are formed on the same plane as in prior art, the patterns are coupled by electrostatic capacity coupling, and the magnetic induction coupled state between the patterns is improved. It is accordingly possible to obtain a high-frequency coupler that has better transmission characteristics in a wide band than in prior art.

### BRIEF DESCRIPTION OF THE DRAWINGS

FIG. 1 is a descriptive view showing only a conductor part of a high-frequency coupler that uses the present invention;

FIG. 2 is a rear view and plan view of the coupler of FIG. 1;

FIG. 3(a) is a circuit diagram showing an equivalent circuit of the coupler of FIG. 1 that is based on a lumped parameter; FIG. 3(b) is a circuit diagram showing an equivalent circuit during matching when a capacity coupling wave source and a magnetic coupling wave source are regarded as a balanced-system equivalent wave source;

FIG. 4 is a rear view and a plan view that show an antenna comprising the coupler (flask-shaped balun) of FIG. 2;

FIG. 5 is a descriptive view showing a multi-layered high-frequency coupler that uses the present invention;

FIG. 6(a) is a descriptive view showing a ferrite core that is currently widely used in baluns, multiplexers, branching filters, and other connection circuit components directly below the antenna to receive VHF and UHF surface wave television broadcasts; FIG. 6(b) is a descriptive view showing a split-slot-form balun between a microwave measuring dipole or loop antenna and a coaxial line; FIG. 6(c) shows an equivalent circuit of FIGS. 6(a) and 6(b), and

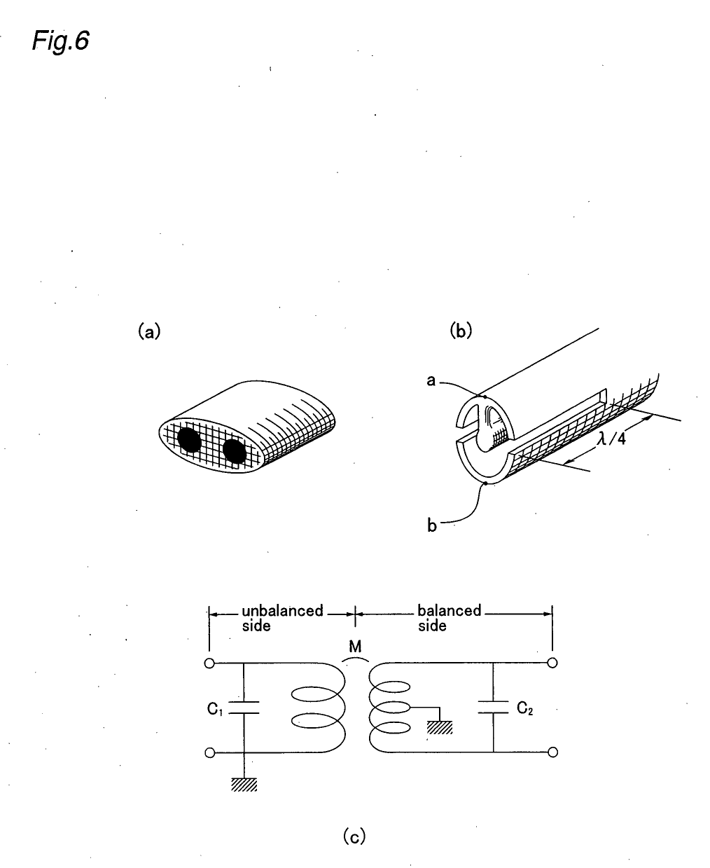

FIG. 7 is a descriptive view showing a conventional planarly configured balun.

### BEST MODE FOR CARRYING OUT THE INVENTION

The present invention shall be described below with reference to the drawings.

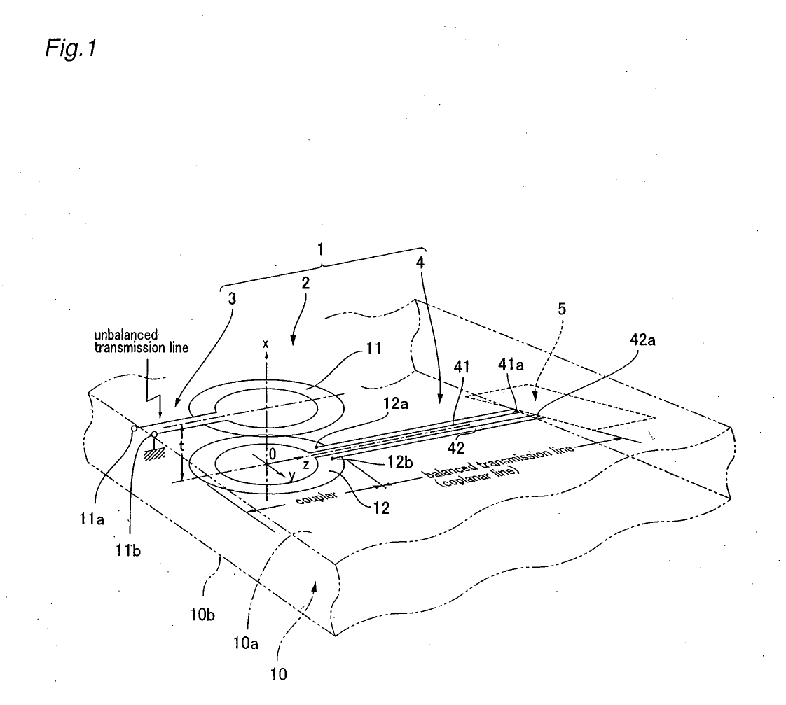

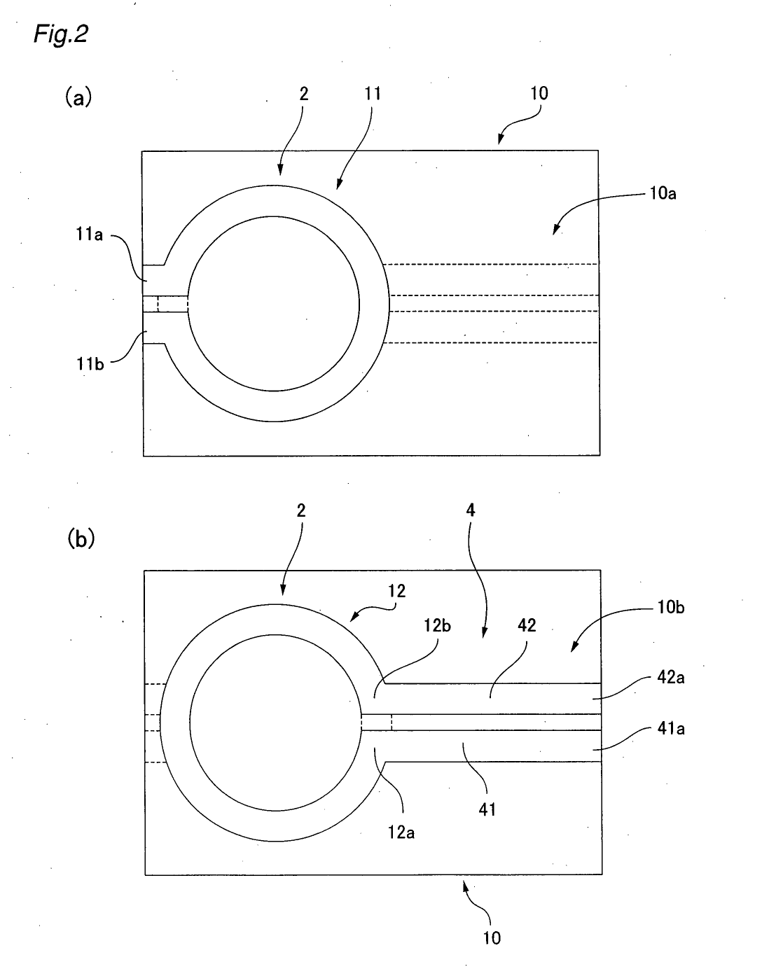

FIG. 1 is a descriptive view showing an RF guide that uses the present invention. FIGS. 2(a) and 2(b) are a rear view and plan view of the RF guide. An RF guide 1 of the present example has a high-frequency coupler 2 and an unbalanced transmission line 3 and balanced transmission line 4 that are mutually coupled via the high-frequency coupler 2.

The high-frequency coupler 2 has a circuit board 10 composed of a dielectric body. A loop-shaped first coupler pattern 11 that is broken in one location is formed from copper foil or the like on a rear surface (first board surface) 10a of the circuit board 10. A loop-shaped second coupler pattern 12 that is broken in one location is similarly formed from copper foil or the like on a front surface (second board surface) 10b. The first and second coupler patterns 11, 12 have, e.g., identical annular shapes.

The positions at which the first and second coupler patterns 11, 12 are broken are at either end along a z-axis direction when a perpendicular line that extends from the front surface of the board and passes through a center of the patterns 11, 12 is an x-axis and a plane parallel to the front surface of the board is a y-z plane. Terminals 11a, 11b of the first coupler pattern 11 are unbalanced terminals. A circuit pattern of the unbalanced transmission line 3 that is formed on the rear surface 10a of the circuit board 10 and is connected to the unbalanced terminals extends in the z-axis direction. Terminals 12a, 12b of the second coupler pattern 12 are balanced terminals. Coplanar lines 41, 42 of the balanced transmission line 4 that is formed on the front surface 10b of the circuit board 10 are connected to the terminals. The coplanar lines 41, 42 follow along the z-axis direction, and extend in a direction opposite that of the balanced transmission line. The resulting tabular coupler 2 is an example of the simplest configuration for a balun, and, for example, a dipolar balanced antenna 5 is connected to terminals 41a, 41b of the coplanar lines 41, 42.

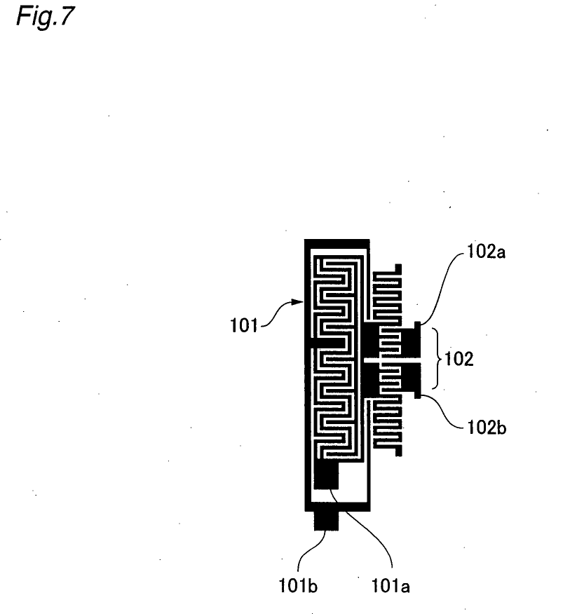

Electrostatic capacity C and mutual induction M between the first and second coupler patterns 11, 12 will increase as long as the thickness t of the circuit board 10 composed of the dielectric body has sufficiently been reduced. As a result, a much greater electrostatic capacity coupling can be generated between the patterns than when the patterns are formed on the same plane of the board as in the conventional configuration shown in FIG. 7. Ferrite is not used to generate magnetic induction coupling. However, the thickness t of the circuit board 10, i.e., the gap t between the patterns 11, 12 is small. Therefore, there is little magnetic flux leakage, and the same coupled state can be achieved as when ferrite is used.

The shapes of the patterns in the present example are examples, and the patterns are not limited to the shapes of the present example. In addition to an annular shape, the coupler patterns can have, e.g., an elliptical shape, a polygonal shape, or a combination thereof. The shapes of the first and second coupler patterns are the same (congruent), but the shapes can also be similar. Different shapes can also be used depending on the application.

In the present example, the circuit board 10 is a flat board having a constant thickness. However, it is also possible to, e.g., use a curved body for the board and layer or print a coupler pattern on curved surfaces on either side of the curved body.

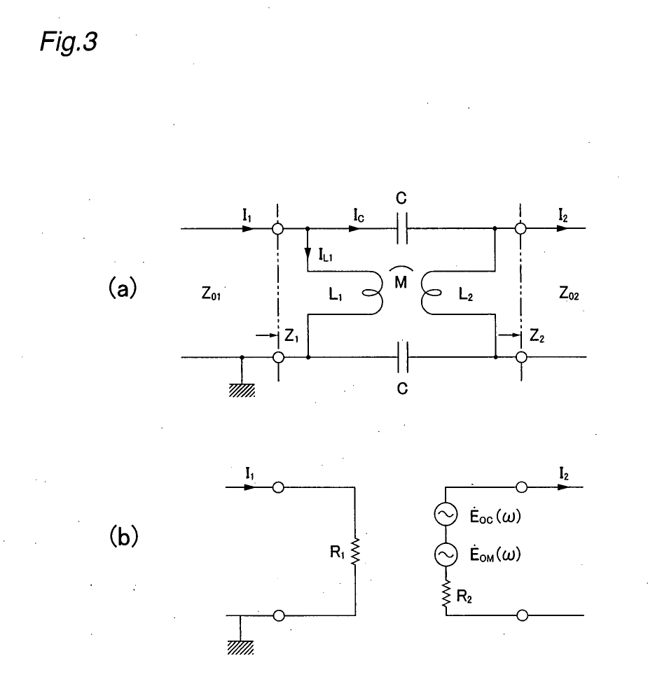

FIGS. 3A and 3B are an equivalent circuit diagram and equivalent power source diagram of the high-frequency coupler 2.

C: Capacity of the capacitor

M: Strength of the coupling or mutual inductance between the coils

L₁, L₂ Self-induced inductance of the coil

Z₀₁, Z₀₂ Characteristic impedance of the circuit on the primary (unbalanced) side and secondary (balanced) side

Z₁, Z₂ Input impedance of the circuit on the primary (unbalanced) side and secondary (balanced) side

R₁, R₂ Resistance of the abovementioned circuits (during matching)

\dot{E}_{0C} (ω) Secondary-side equivalent electromotive force resulting from capacity coupling (C coupling electromotive force)

\dot{E}_{0M}·(ω) Secondary-side equivalent electromotive power resulting from magnetic coupling (M coupling electromotive force)

ω angular frequency of the electromagnetic waves.

The equivalent circuit diagram shown in FIG. 3A shows the equivalent circuit of the high-frequency circuit 2 along with the characteristic inductance Z₀₁, Z₀₂ of the circuits 3, 4 that are laterally connected. At first glance, the circuit appears to be a high-pass filter. However, the ratio between power currents I_{L1} and I_{C} changes in accordance with the angular frequency ω of the electromagnetic waves. Therefore, the desired broadband characteristics and separation band characteristics can be obtained by suitably selecting a crossover frequency f_{C} with the magnetic induction coupling.

The equivalent power source diagram shown in FIG. 3B is a diagram of the equivalent power source during matching performed when the equivalent wave source is considered for the secondary circuit. The C coupling electromotive force and M coupling electromotive force are both functions of the frequency f. The C coupling electromotive force has a dramatic effect at high frequencies in the pass band and the M coupling electromotive force is dominant at low frequencies. The electromotive forces function so that the vector sum thereof is as shown in the following equation.
\dot{E}₀(ω)=\dot{E}_{0C}(ω)+\dot{E}_{0M}(ω)

Strictly speaking, the equivalent circuit itself is thus not expressed by a lumped parameter, and must be treated as a distributed parameter circuit.

When the RF guide 1 of the present example is used as an antenna balun, the first and second coupler patterns 11, 12 are, e.g., annular in shape and have a diameter of about 30 mm. A double-sided conductive foil printed board having a thickness t of about 0.3 mm is used for the circuit board 10. This configuration is suitably used in a balun for UHF band television broadcasting. In this instance, it is necessary to match the characteristic impedance of the coplanar line 4 with the input impedance of the antenna 5 and to suitably set the length [of the coplanar line].

Even when the antenna 5 is not connected to the terminals 41, 42, the length of the coplanar line 4 and other factors are suitably set, thereby yielding applications as a flask-shaped indoor television reception antenna for television reception without further alteration.

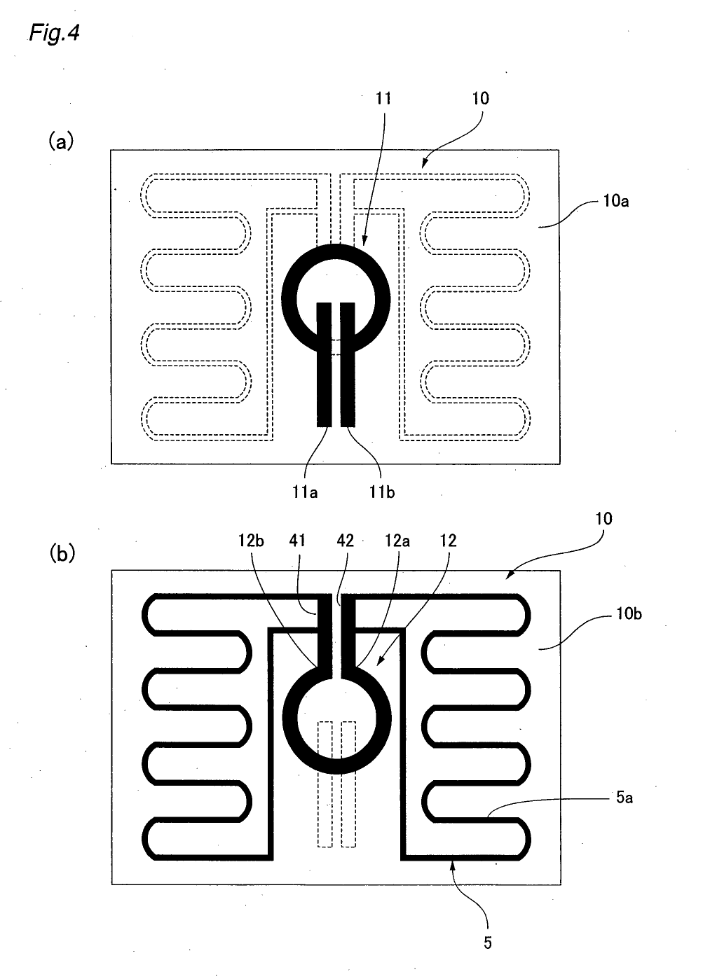

FIGS. 4(a) and 4(b) are a rear view and plan view that show an example of a balun-equipped antenna having a configuration in which the antenna pattern is also formed integrally on the circuit board. In FIGS. 4(a) and 4(b), the same symbols are used to mark regions that correspond to parts of FIGS. 1 and 2. When an antenna pattern 5a is also integrally formed on the front surface of the circuit board 2, the manufacturing process is simplified, and a separately formed antenna does not need to be connected. Accordingly, manufacturing costs can be reduced. The shapes of the patterns of the present example are examples, and the patterns are not limited to these shapes.

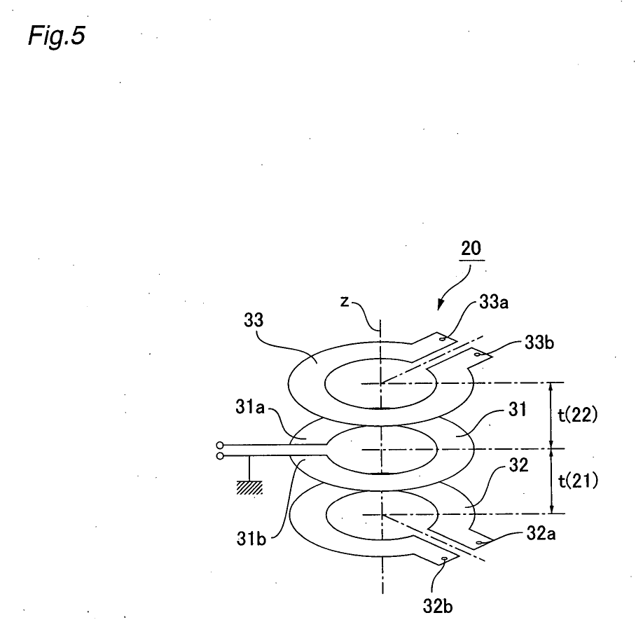

FIG. 5 is a descriptive view showing a multi-layered high-frequency coupler that uses the present invention. A coupler 20 shown in FIG. 5 has a first circuit board of thickness t(21) and a second circuit board of thickness t(22) that is layered on a front surface of the first circuit board. In FIG. 5, the circuit boards are omitted and only the thickness t(21) and the thickness t(22) are shown in order to make the drawing easier to understand. The thicknesses should in general be the same, but may also be different depending on the application.

A first coupler pattern 31 is formed between the first and second circuit boards, a second coupler pattern 32 is formed on a rear surface of the first circuit board, and a third coupler pattern 33 is formed on a front surface of the second circuit board. The first through third coupler patterns 31 through 33 are, e.g., annular in shape and broken at one location. The broken locations (openings) are offset in a circumferential direction about a z-axis that passes through the centers of the coupler patterns and that is perpendicular to the boards.

For example, terminals 31a, 31b of the first coupler pattern 31 are connected to an unbalanced transmission line, and terminals 32a, 32b and 33a, 33b of the second and third coupler patterns 32, 33 are each connected to a balanced transmission line. Since a degree of latitude is allowed for the design of the circuit configuration ahead of the terminals, the circuit can be used to connect two antennas having different frequency bands and input impedances.

A high-frequency coupler having a configuration in which four or more couplers are similarly layered can also be formed. In a multi-layered structure having three or more layers, the circuits formed on the circuit board are often all balanced or unbalanced. However, this selection is determined solely by the grounding of components outside the circuit board, and therefore the coupler pattern itself can be shared in all instances.

The high-frequency coupler that uses the present invention has the following advantages over conventional baluns and other conventional linear couplers:

(1) Lower weight, smaller size

(2) Reduced production costs

(3) Improvements in transmission characteristics (reduced insertion loss, widened operation frequency range)

In other words, a thin printed board is used as a circuit board composed of a dielectric body, whereby weight and size can be reduced. In addition, the balun or other transformer or coupler is formed integrally with the adjacent transmission circuit and transmission circuit elements, whereby a dramatic reduction in manufacturing costs can be achieved.

Insertion loss can be improved by avoiding ferrite cores used in conventional products, and by using a thin board having low RF loss. The bandwidth can be increased by making loops having a size and shape designed for the selected thin board, and layering the loops precisely. Accordingly, the transmission characteristics can be markedly improved.

Such effects are exhibited in a variety of transmission circuits and adjacent elements that operate linearly in VHF, UHF, and SHF frequency ranges. In the microwave band, there are isolators, circulators, and the like that have traditionally employed the anisotropy of ferrite or the like. However, there are also many components that only employ the low loss and high permeability of ferrite, such as with RF transformers. Ferrite has been required despite the fact that the latter preferably has an inherently linear operation. Therefore, nonlinear operation has been needed in large-amplitude circumstances, and baluns, branching filters, and other couplers have had a three-dimensional structure. However, with the recent emergence of thin high-quality RF boards, planar loops (loop-shaped coupler patterns formed on a circuit board) can be brought sufficiently close together, whereby satisfactory magnetic coupling can be obtained without the use of ferrite. In addition, the thinness of the circuit board assures sufficient electrostatic capacity with respect to the RF. Therefore, by disposing the loops so as to constitute the aforedescribed equivalent circuit shown in FIG. 3, a magnetic and electrostatic capacity coupling can be formed simultaneously.

1. A high-frequency coupler characterized in comprising:
a circuit board composed of a dielectric body;
a loop-shaped first coupler pattern that is formed on a first board surface of the circuit board and is broken at one location; and
a loop-shaped second coupler pattern that is formed on a second board surface of the circuit board and is broken at one location; wherein
the first coupler pattern and second coupler pattern sandwich the circuit board and are disposed facing each other so that a state of electrostatic capacity coupling and a state of magnetic induction coupling are established.

2. The high-frequency coupler of claim 1 characterized in that the first coupler pattern and second coupler pattern have congruent or similar shapes.

3. The high-frequency coupler of claim 2 characterized in that the first coupler pattern and second coupler pattern are disposed so that the broken positions thereof are offset 180° about an axis line that is perpendicular to the circuit board.

4. An RF guide characterized in comprising:
the high-frequency coupler of claim 1;
a first high-frequency transmission line pattern that is formed on the first board surface of the circuit board and is connected to both ends of the first coupler pattern (*2); and
a second high-frequency transmission line pattern that is formed on the second board surface of the circuit board and is connected to both ends of the second coupler pattern (*2).

5. The RF guide of claim 4 characterized in that
the first high-frequency transmission line pattern is an unbalanced transmission line pattern; and
the second high-frequency transmission line pattern is a balanced transmission line pattern.

6. A balun-equipped antenna characterized in comprising:
the RF guide of claim 5; and
an antenna pattern that is formed on the first board surface of the circuit board and is connected to the unbalanced transmission line pattern.

7. A high-frequency coupler characterized in comprising:
a first circuit board composed of a dielectric body;
a second circuit board that is composed of a dielectric body and is layered on a front surface of the first circuit board;
a loop-shaped first coupler pattern that is formed on a rear surface of the first circuit board and is broken at one location;
a loop-shaped second coupler pattern that is formed between the first circuit board and second circuit board and is broken at one location; and
a loop-shaped third coupler pattern that is formed on a front surface of the second circuit board; wherein
the first and second coupler patterns sandwich the first circuit board and are disposed facing each other so that a state of mutual electrostatic capacity coupling and a state of magnetic induction coupling are established; and
the second and third coupler patterns sandwich the second circuit board and are disposed facing each other so that a state of mutual electrostatic capacity coupling and a state of magnetic induction coupling are established.

8. The high-frequency coupler of claim 7 characterized in that the first, second, and third coupler patterns have congruent or similar shapes.

9. The high-frequency coupler of claim 8 characterized in that the first, second, and third coupler patterns are disposed so that the broken positions thereof are offset about an axis line that is perpendicular to the first and second circuit boards.
